(19) United States
(12) Patent Application Publication
(10) Pub. No.: US 2006/0132390 A1
(43) Pub. Date: Jun. 22, 2006

(54) Plasma display device and method of driving the same

(76) Inventors: Won Jae Kim, Masan-si (KR); Kyung Ryeol Shim, Nam-gu (KR); Ki Duck Cho, Gumi-si (KR); Min Soo Kim, Gumi-si (KR)

Correspondence Address: MCKENNA LONG & ALDRIDGE LLP;Song K. Jung, 1900 K Street, N.W., Washington, DC, 20006, US

(21) Appl. No.: 11/304,571

(22) Filed: Dec. 16, 2005

(30) Foreign Application Priority Data
Dec. 18, 2004 (KR) P2004-108448

(51) Int. Cl. G09G 3/28

(52) U.S. Cl. 345/67

(57) ABSTRACT

The present invention relates to a plasma display device and a method of driving the same. By partially overlapping the sustain pulses applied to the scan and sustain electrodes, during the sustaining period, sustain discharges are achieved during certain voltage variation intervals such that discharge efficiency and brightness are improved, image sticking is minimized and power consumption is reduced.

This application claims the benefit of Korean Patent Application No. P2004-108448 filed in Korea on Dec. 18, 2004, which is hereby incorporated by reference.

### BACKGROUND OF THE INVENTION

1. Field of the Invention

The present invention relates to a plasma display panel, and more particularly, to a plasma display device and a method of driving the same that is capable of minimizing image sticking.

2. Description of the Related Art

Generally, a plasma display panel (PDP) excites and radiates a phosphorus material using an ultraviolet ray generated upon discharge of an inactive gas mixture such as He+Xe, Ne+Xe or He+Ne+Xe, to thereby display a picture. Such a PDP is easily made into a thin-film and large-dimension type PDP. Moreover, the PDP provides improved picture quality owing to recent technical developments.

Referring to FIG. 1, a discharge cell of a related art three-electrode, alternating current (AC) surface-discharge PDP includes a scan electrode Y and a sustain electrode Z provided on an upper substrate 16, and an address electrode X provided on a lower substrate 14.

Both the scan electrode Y and the sustain electrode Z include a transparent electrode and a metal bus electrode, the latter having a width that is less than the width of the transparent electrode, and wherein, the metal bus electrode is aligned with one edge of the transparent electrode. The transparent electrode is usually formed from indium-tin-oxide (ITO) on the upper substrate 16. The metal bus electrode is usually formed from a metal such as chrome (Cr) and the like on the transparent electrode, to thereby reduce voltage drop caused by the transparent electrode having a high resistance.

On the upper substrate 16 provided, in parallel, with the scan electrode Y and the sustain electrode Z, an upper dielectric layer 12 and a protective film 10 are disposed. Wall charges generated upon plasma discharge accumulate on the upper dielectric layer 12. The protective film 10 prevents damage to the upper dielectric layer 12 caused by sputtering during the plasma discharge and improves the emission efficiency of secondary electrons. The protective film 10 is usually made from magnesium oxide (MgO).

A lower dielectric layer 18 and barrier ribs 8 are formed on a lower substrate 14 provided with the address electrode X. The surfaces of the lower dielectric layer 18 and the barrier ribs 8 are coated with a phosphorous material 6. The address electrode X is formed in a perpendicular direction relative to the scan electrode Y and the sustain electrode Z. The barrier rib 8 is formed parallel to the address electrode X to thereby prevent ultraviolet light and visible light generated during a discharge from leaking into adjacent discharge cells. The phosphorous material 6 is excited by the ultraviolet light that is generated during the plasma discharge to generate any one of red, green and blue visible light rays. An inactive gas mixture is injected into the discharge space defined between the upper and lower substrate 16 and 14 and the barrier ribs 6.

Such a PDP employs time-divided frames, each of which is, more specifically, divided into various sub-fields having a different emission frequency, so as to realize different gray levels in a picture. Each sub-field is divided into a reset period for initializing the entire field, an address period for selecting each address electrode is sequence and selecting certain cells along each address electrode, and a sustain period for expressing gray levels in selected cells depending on the discharge frequency. Herein, the reset period is divided into a set-up interval supplied with a rising ramp waveform and a set-down interval supplied with a falling ramp waveform.

For instance, when it is intended to display a picture of 256 gray levels, a frame interval equal to 1/60 second (i.e. 16.67 msec) is divided into 8 sub-fields SF1 to SF8. Each of the 8 sub-field SF1 to SF8 is divided into a reset period, an address period and a sustain period as mentioned above. Herein, the reset period and the address period of each sub-field are the same for each sub-field, whereas the sustain period increases at a ratio of 2ⁿ (wherein n=0, 1, 2, 3, 4, 5, 6 and 7) for each of the eight sub-fields.

FIG. 2 shows a driving waveform of a PDP applied during one sub-field. In FIG. 2, Y represents the scan electrode; Z represents the sustain electrode; and X represents the address electrode.

In the reset period RPD, a reset pulse RP is applied to the scan electrode Y. The reset pulse RP has an increasing voltage ramp waveform during the set-up interval and a decreasing voltage ramp waveform during the set-down interval. In the set-up interval, a reset discharge is generated between the scan electrode Y and the sustain electrode Z to cause a weak discharge within the full field of cells (i.e., all cells), to thereby generate wall charges within all of the cells. Sequentially, spurious charges are partially erased by the voltage decrease in the set-down interval, so that the wall charges do not cause a miss discharge, and they are decreased only as much as required to achieve address discharge. To decrease these wall charges, a direct current voltage Vs of a positive polarity (+) is applied to the sustain electrode Z in the set-down interval of the reset pulse RP. Since the reset pulse RP corresponding to the direct current voltage Vs of the positive polarity (+) is gradually applied in a decreasing manner, the scan electrode Y has a negative polarity (−) in opposition to the sustain electrode Z in the set-down interval. In other words, polarity is inversed, to thereby decrease the wall charges generated in the set-up interval. As mentioned above, the reset discharge is generated by supplying the reset pulse RP, resulting in the wall charges required for the address discharge, the wall charges are formed identically within the full field (i.e., all) cells.

In the address period APD, a scanning pulse SP is applied to the scan electrode Y and, at the same time, a data pulse is applied to the address electrode X, to thereby generate an address discharge in the cell corresponding to this Y and this Z electrode. Wall charges formed by the address discharge are maintained while other select discharge cells are addressed.

In the sustain period SPD, after a first sustain pulse SUSPY of a sustain voltage is applied to the scan electrode Y, sustain pulses SUSPY and SUSPZ are alternatively applied to the sustain electrode Z and the scan electrode Y. Accordingly, a wall voltage within the cells selected during the address period is added to the sustain voltage Vsus to thereby generate a sustain discharge in those selected cells, that is, a display discharge, between the scan electrodes Y and the sustain electrode Z whenever sustain pulses SUSPY and SUSPZ are applied. In other words, in the sustain period SPD, when a voltage of the scan electrode Y rises from the ground voltage GND to the sustain voltage Vsus in a state that the ground voltage GND is applied to the sustain electrode Z and the address electrode X, a strong surface discharge is generated between the scan electrode Y and the sustain electrode Z. When a voltage of the sustain electrode Z rises from the ground voltage GND to the sustain voltage Vsus in a state that the ground voltage GND is applied to the scan electrode Y and the address electrode X, a strong surface discharge is generated between the sustain electrode Z and the scan electrode Y.

On the other hand, the sustain discharge does not occur in non-selected cells that are not selected in the address period because the sum of the wall voltage within the non-selected cells and an external voltage is lower than the firing voltage, during the sustain period SPD. After the completion of the sustain discharge, an erasing signal (not shown) for erasing the wall charge remaining within the cells is applied to the scan electrode Y or the sustain electrode Z.

As mentioned above, the general driving method of conventional PDPs has a problem in that image sticking occurs when a specific picture is displayed for a definite time (i.e., when a still picture is displayed) as a result of a discharge delay of the sustain discharge.

### SUMMARY OF THE INVENTION

Accordingly, it is an object of the present invention to provide a plasma display device and a method of driving the same that is capable of minimizing image sticking.

In accordance with a first aspect of the present invention, the above-identified and other objects are achieved by a plasma display device. The plasma display device comprises a first driver configured for applying a first sustain pulse to a first electrode, where the first sustain pulse has a high voltage level and a low voltage level. The plasma display device also comprises a second driver configured for applying a second sustain pulse to a second electrode, where the second sustain pulse has a high voltage level and a low voltage level. In addition, the plasma display device comprises a controller configured for changing the voltage level of the first sustain pulse while the voltage level of the second sustain pulse is maintained at the high voltage level.

In accordance with another aspect of the present invention, the above-identified and other objects are achieved by a method of driving a plasma display device. The method involves applying a first sustain pulse to a first electrode, where the first sustain pulse has a high voltage level and a low voltage level, and applying a second sustain pulse to a second electrode, where the second sustain pulse has a high voltage level and a low voltage level. The method also involves changing the voltage level of the first sustain pulse while maintaining the voltage level of the second sustain pulse at the high voltage level.

In accordance with yet another aspect of the present invention, the above-identified and other objects are achieved by a method of driving a plasma display device. The method involves applying a first sustain pulse to a first sustain electrode, where the first sustain electrode has a high voltage level and a low voltage level, and applying a second sustain pulse to a second electrode, where the second sustain electrode has a high voltage level and a low voltage level. In addition, the method involves changing the voltage level of the first sustain pulse while maintaining the voltage of the second sustain pulse at the high voltage level, and changing the voltage level of the second sustain pulse while maintaining the voltage of the first sustain pulse at the high voltage level.

### BRIEF DESCRIPTION OF THE DRAWINGS

These and other objects of the invention will be apparent from the following detailed description of the embodiments of the present invention with reference to the accompanying drawings, in which:

FIG. 1 is a perspective view showing a related art AC surface-discharge plasma display panel;

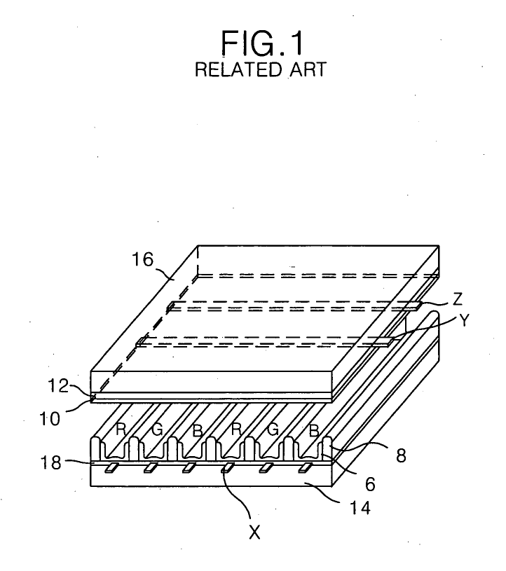

FIG. 2 is a diagram of a driving waveform for the related art PDP shown in FIG. 1;

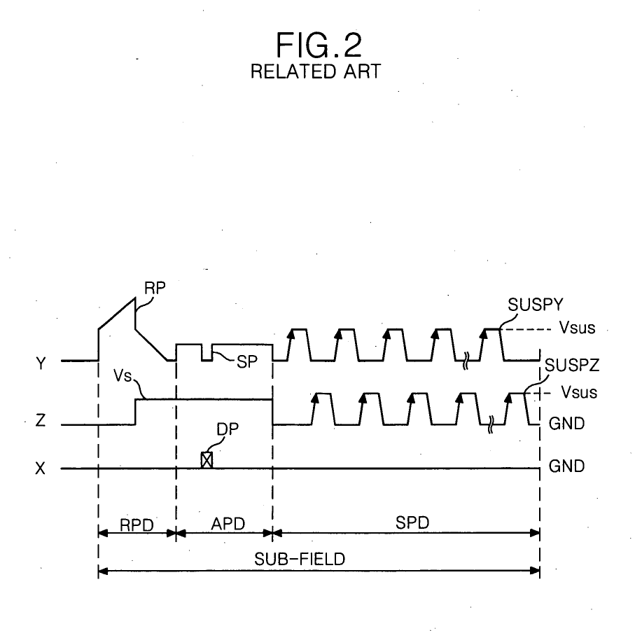

FIG. 3 is a diagram of a driving waveform for a PDP according to a first embodiment of the present invention;

FIG. 4 is a diagram of a waveform illustrating an enlarged portion ‘A’ of the sustain period shown in FIG. 3;

FIG. 5 is a graph showing an example value for a sustain discharge according to the driving waveform in FIG. 3;

FIG. 6 is a waveform for driving a PDP according to a second embodiment of the present invention;

FIG. 7 is a diagram of a waveform illustrating an enlarged portion ‘B’ of the sustain period shown in FIG. 6;

FIG. 8 is a graph showing an example value for a sustain discharge according to the driving waveform in FIG. 6;

FIG. 9 is a waveform for driving a PDP according to a third embodiment of the present invention;

FIG. 10 is a diagram of a waveform illustrating an enlarged portion ‘C’ of the sustain period shown in FIG. 9; and

FIG. 11 is a graph showing an example value for a sustain discharge according to the driving waveform in FIG. 9.

### DETAILED DESCRIPTION OF THE EXEMPLARY EMBODIMENTS

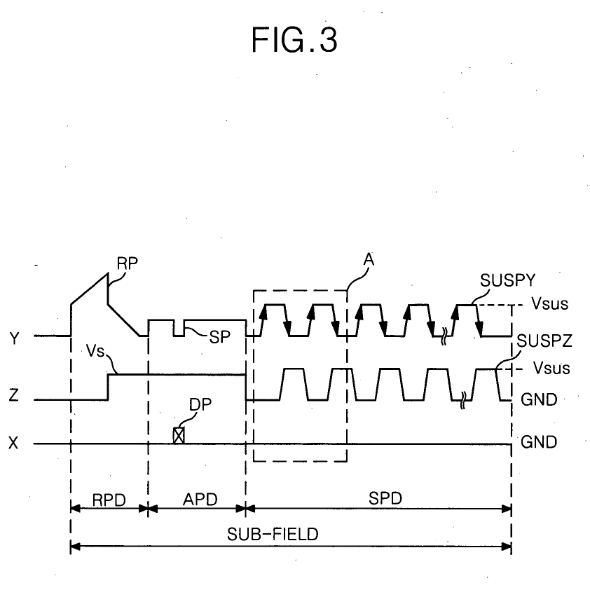

Reference will now be made in detail to the preferred embodiments of the present invention, examples of which are illustrated in the accompanying drawings. Hereinafter, the preferred embodiments of the present invention will be described in detail with reference to FIGS. 3. to 11.

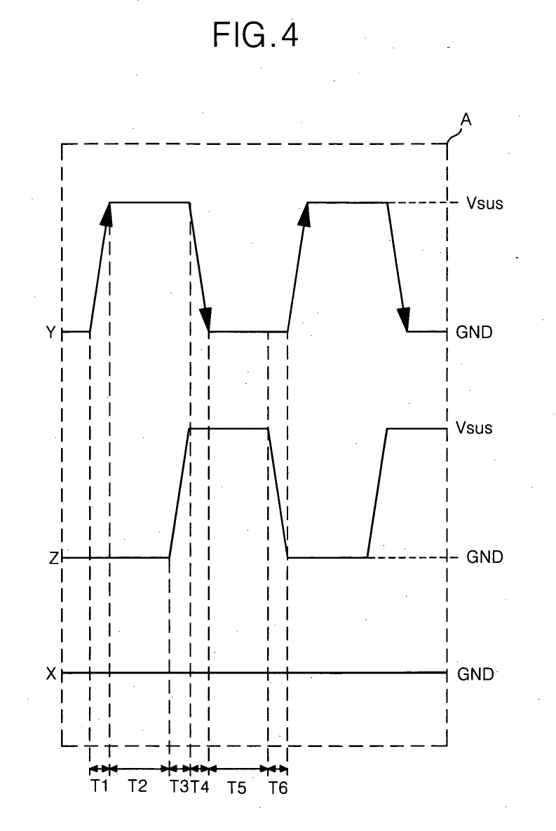

FIG. 3 is a diagram of a waveform illustrating a driving method for a PDP according to a first embodiment of the present invention. FIG. 4 is a diagram of a waveform illustrating an enlarged portion ‘A’ for the sustain period shown in FIG. 3.

Referring to FIGS. 3 and 4, the driving waveform for a PDP according to the first embodiment of the present invention is divided into: a reset period RPD to apply a reset pulse RP to a scan electrode Y for each sub-field of one frame so as to generated a reset discharge, to thereby initialize a discharge cell, in order to display a designated image; an address period APD to supply a data pulse to an address electrode X and, at the same time, to apply a scanning pulse SP to the scan electrode Y so as to generate an address discharge, to thereby select the discharge cell; and a sustain period SPD to partially overlap a first sustain pulse SUSPY applied to the scan electrode Y with a second sustain pulse SUSPZ applied to the sustain electrode Z so as to generate a sustain discharge every rising interval T1 and falling interval T2 of the first sustain pulse SUSPY, to thereby maintain the discharge selected in the address period APD.

In the reset period RPD, a reset pulse RP is applied to the scan electrode Y. The reset pulse RP has an increasing voltage ramp waveform in a set-up interval and a decreasing voltage ramp waveform in a set-down interval. In the set-up interval, a reset discharge is generated between the scan electrode Y and the sustain electrode Z to cause a weak discharge within the full field of cells, to thereby generate wall charges within the cells. Then, spurious charges are partially erased by the voltage decrease in the set-down interval, so that the wall charges do not cause any miss discharge, where the wall charges are decreased as much as required for an address discharge. To decrease these wall charges, a direct current voltage Vs of a positive polarity (+) is applied to the sustain electrode Z in the set-down interval of the reset period RPD. Since the reset pulse RP corresponding to the direct current voltage Vs of the positive polarity (+) is gradually applied in a decreasing manner, the scan electrode Y has a negative polarity (−) in opposition to the sustain electrode Z in the set-down interval. In other words, polarity is inversed, to thereby decrease the wall charges generated in the set-up interval. As mentioned above, the reset discharge is generated by the reset pulse RP and the wall charges required for the address discharge are formed identically within all of the cells of the full field.

In the address period APD, a scanning pulse SP is applied to the scan electrode Y and, at the same time, a data pulse DP is applied to the address electrode X, to thereby generate an address discharge. Wall charges formed by the address discharge are maintained while other discharge cells are addressed.

In the sustain period SPD, first and second sustain pulses SUSPY and SUSPZ of a sustain voltage Vsus are alternatively applied to the scan electrode Y and the sustain electrode Z. At this time, the second sustain pulse SUSPZ is applied to the sustain electrode Z such that it partially overlaps the first sustain pulse SUSPY as shown in FIG. 4. Accordingly, a sustain discharge is generated during rising interval T1, where the voltage level of the first sustain pulse SUSPY rises, and during falling interval T4, where the voltage level of the first sustain pulse SUSPZ is falling. In other words, in the sustain period SPD, the wall voltage within a cell selected during the address period APD is the result of the address discharge plus the additional sustain voltage Vsus, thus, a sustain discharge, that is, a display discharge, is generated every rising interval T1 and every falling interval T4 of the first sustain pulse SUSPY applied to the scan electrode Y. At this time, the first sustain pulse SUSPY rises from the ground voltage GND to the sustain voltage Vsus in the first interval T1 of a low potential clamping interval, during which time the second sustain pulse SUSPZ maintains the ground voltage GND, falls from the sustain voltage Vsus to the ground voltage GND in the fourth interval T4 of a high potential clamping interval, which the second sustain pulse SUSPZ maintains the sustain voltage Vsus, and maintains the ground voltage GND in the fifth interval T5 of the high potential clamping interval, during which time the second sustain pulse SUSPZ maintains the sustain voltage Vsus, and in the sixth interval, during which time the second sustain pulse SUSPZ falls from the sustain voltage Vsus to the ground voltage GND. Further, the first sustain pulse SUSPY maintains the sustain voltage Vsus in the second interval T2 of the low potential clamping interval, during which time the second sustain pulse SUSPZ maintains the ground voltage GND, and in the third interval T3, during which time the second sustain pulse SUSPZ rises from the ground voltage GND to the sustain voltage Vsus. Herein, only the rising interval, the maintaining interval, and the falling interval of the second sustain pulse SUSPZ are different as compared with those of the first sustain pulse SUSPY. The second sustain pulse SUSPZ rises, maintains, and falls at the same timing as the first sustain pulse SUSPY.

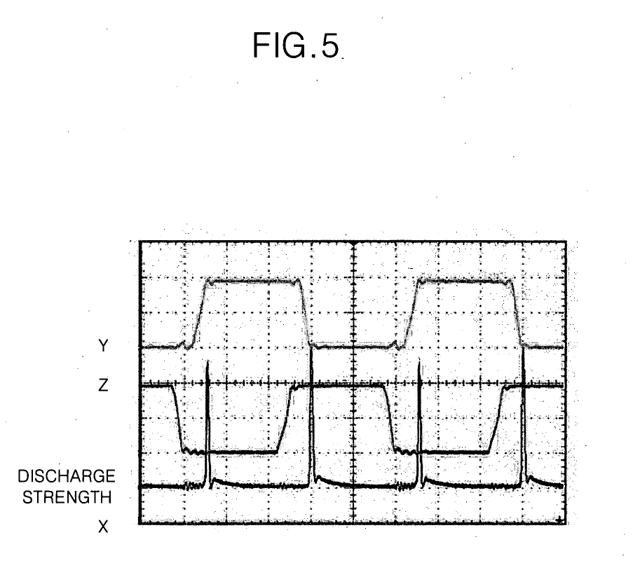

More particularly, a strong surface discharge is generated between the scan electrode Y and the sustain electrode Z as a result of the rising voltage of the first sustain pulse SUSPY in the T1 interval, where the voltage of the first sustain pulse SUSPY applied to the scan electrode Y rises from the ground voltage GND to the sustain voltage Vsus while at the same time, the ground voltage GND is applied to the sustain electrode Z and the address electrode X. Subsequently, a strong surface discharge is generated between the sustain electrode Z and the scan electrode Y as a result of the falling voltage of the first sustain pulse SUSPY, and at the same time an opposition discharge is generated between the sustain electrode Z and the address electrode X in the T4 interval, where the voltage of the first sustain pulse SUSPY applied to the scan electrode Y falls from the sustain voltage Vsus to the ground voltage GND, while the ground voltage GND is applied to the address electrode X and the second sustain pulse SUSPZ of the sustain voltage Vsus applied to the sustain electrode Z. The sustain discharge generated in the sustain period SPD, as shown in FIG. 5, is greater during the falling interval T4, where the voltage level of the first sustain pulse SUSPY falls, than during the rising interval T1, where the voltage level of the first sustain pulse SUSPY rises.

On the other hand, the sustain discharge does not occur in non-selected cells, that is, cells that were not selected in the address period. That is because the sum of the wall voltage within the non-selected cells and an external voltage is lower than the firing voltage, during the sustain period SPD.

After the completion of the sustain discharge, an erasing signal (not shown) for erasing the wall charge remaining within the cells is applied to the scan electrode Y or the sustain electrode Z.

As mentioned above, the driving method of a PDP according to the first embodiment of the present invention generates a sustain discharge every rising interval T1 and the falling interval T4 of the first sustain pulse SUSPY applied to the scan electrode Y, to thereby minimize a discharge delay of the sustain discharge. Thus, it is possible to minimize image sticking caused when a picture is displayed over a particular time period (i.e., when a still picture is displayed over a particular time period). Further, the driving waveform for a PDP according to the first embodiment of the present invention partially overlaps the first sustain pulse SUSPY with second sustain pulse SUSPZ to simultaneously generate the surface discharge and the opposition discharge in the sustain period SPD, to thereby improve discharge efficiency and brightness, and to decrease the sustain period SPD, to thereby reduce power consumption.

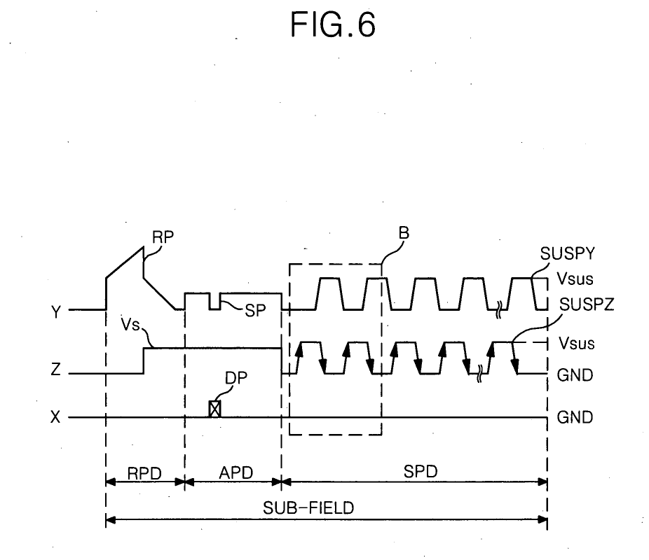

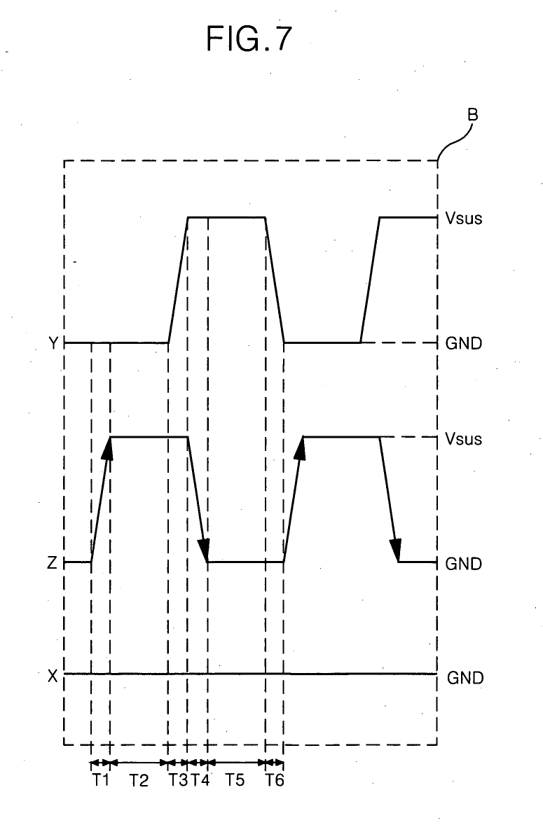

FIG. 6 is a diagram of a waveform illustrating a driving method of a PDP according to a second embodiment of the present invention. FIG. 7 is a diagram of a waveform illustrating an enlarged portion ‘B’ of the sustain period shown in FIG. 6.

Referring to FIGS. 6 and 7, the driving waveform of the PDP according to the second embodiment of the present invention is divided into: a reset period RPD to apply a reset pulse RP to a scan electrode Y for each sub-field of one frame so as to generated a reset discharge, to thereby initialize a discharge cell, in order to display a designated image; an address period APD to supply a data pulse to an address electrode X and at the same time to apply a scanning pulse SP to the scan electrode Y so as to generate an address discharge, to thereby select the discharge cell; and a sustain period SPD to partially overlap a second sustain pulse SUSPZ applied to the sustain electrode Z with a first sustain pulse SUSPY applied to the scan electrode Y so as to generate a sustain discharge every rising interval T1 and falling interval T4 of the second sustain pulse SUSPZ, to thereby, maintain a discharge in cells selected during the address period APD.

The driving method of the PDP according to the second embodiment of the present invention is similar to the first embodiment of the present invention, except for the sustain period SPD. Accordingly, for the second embodiment of the present invention, descriptions of the reset period RPD and the address period APD are omitted; a description of the sustain period SPD is set forth herein below.

In the sustain period of driving method of a PDP according to the second embodiment of the present invention, second sustain pulses SUSPZ and first sustain pulses SUSPY having a sustain voltage Vsus are alternatively applied to the sustain electrode Z and the scan electrode Y, respectively. In other words, in the driving method of a PDP according to the second embodiment of the present invention, in the sustain period, the first sustain pulse SUSPY of the sustain voltage level is applied to the scan electrode Y as illustrated in FIG. 6 and FIG. 7, such that it partially overlaps with the second sustain pulse SUSPZ after the second sustain pulse SUSPZ having the sustain voltage Vsus is applied to the sustain electrode Z. Accordingly, during the sustain period SPD, the sustain voltage Vsus is added to the wall voltage within a cell selected during the address period APD, to thereby generate a sustain discharge, that is, a display discharge, every rising interval T1, where the voltage level of the second sustain pulse SUSPZ applied to the sustain electrode Z rises, and every falling interval T4, where the voltage level of the second sustain pulse SUSPZ falls. At this time, the second sustain pulse SUSPZ rises from the ground voltage GND to the sustain voltage Vsus in the first interval T1 of a low potential clamping interval, at which time the first sustain pulse SUSPY maintains the ground voltage GND. The second sustain pulse SUSPZ then maintains the sustain voltage Vsus in the second interval T2 and the third interval T3, at which time the first sustain pulse SUSPY rises from the ground voltage GND to the sustain voltage Vsus. The second sustain pulse SUSPZ then falls from the sustain voltage Vsus to the ground voltage GND in the fourth interval T4 of a high potential clamping interval, at which time the first sustain pulse SUSPY maintains the sustain voltage Vsus. Further, the second sustain pulse SUSPZ maintains the ground voltage GND in the fifth interval T5 of the high potential clamping interval, at which time the first sustain pulse SUSPY maintains the sustain voltage Vsus, and in the sixth interval, at which time the first sustain pulse SUSPY falls from the sustain voltage Vsus to the ground voltage GND. Herein, only the rising interval, the maintaining interval, and the falling interval of the first sustain pulse SUSPY are different as compared with those of the second sustain pulse SUSPZ. The first sustain pulse SUSPY rises, maintains, and falls at the same timing as the second sustain pulse SUSPZ.

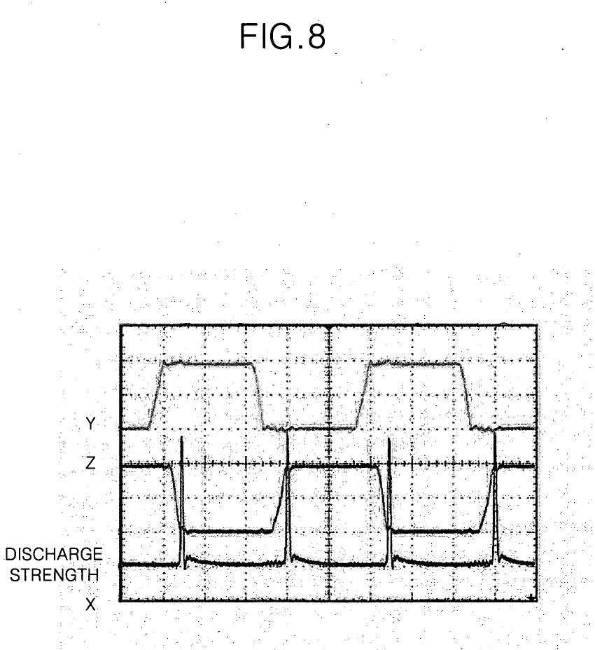

More particularly, a strong surface discharge is generated between the sustain electrode Z and the scan electrode Y as a result of the rising voltage level of the second sustain pulse SUSPZ in the T1 interval, at which time the voltage of the second sustain pulse SUSPZ applied to the sustain electrode Z rises from the ground voltage GND to the sustain voltage Vsus, while at the same time, the ground voltage GND is applied to the scan electrode Y and the address electrode X. Subsequently, a strong surface discharge is generated between the scan electrode Y and the sustain electrode Z as a result of the falling voltage level of the second sustain pulse SUSPZ, and at the same time an opposition discharge is generated between the scan electrode Y and the address electrode X in the T4 interval, where the voltage of the second sustain pulse SUSPZ applied to the sustain electrode Z falls from the sustain voltage Vsus to the ground voltage GND and where the ground voltage GND is applied to the address electrode X and the sustain voltage Vsus is applied to the scan electrode Y. At this time, the sustain discharge generated in the sustain period SPD, as shown in FIG. 8, is greater during the rising interval T1, where the voltage level of the second sustain pulse SUSPZ rises, than during the falling interval T4, where the voltage level of the second sustain pulse SUSPZ falls.

On the other hand, a sustain discharge does not occur in non-selected cells, that is, cells not selected in the address period APD because the sum of the wall voltage within the non-selected cells and an external voltage is lower than the firing voltage during the sustain period SPD.

After the completion of the sustain discharge, an erasing signal (not shown) for erasing the wall charge remaining within the cells is applied to the scan electrode Y or the sustain electrode Z.

As mentioned above, the driving method of a PDP according to the second embodiment of the present invention generates a sustain discharge every rising interval T1 and every falling interval T4 of the second sustain pulse SUSPZ, which is applied to the sustain electrode Z, to thereby minimize the discharge delay associated with the sustain discharge. Thus, it is possible to minimize image sticking caused when a picture (e.g., a still image) is displayed over a given time period. Further, the driving method of a PDP according to the second embodiment of the present invention involves the partial overlap of the first sustain pulse SUSPY with the second sustain pulse SUSPZ to simultaneously generate a surface discharge and an opposition discharge in the sustain discharge, to thereby improve a discharge efficiency and brightness and to decrease the sustain period SPD, thereby reducing power consumption.

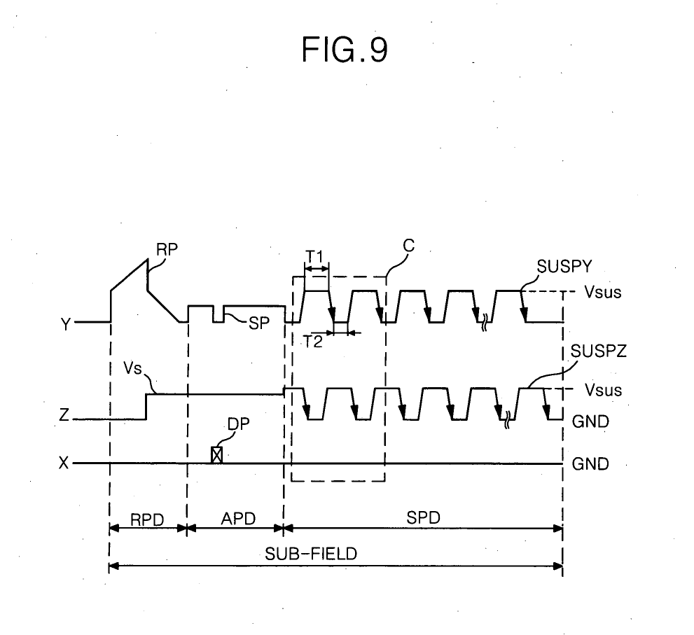

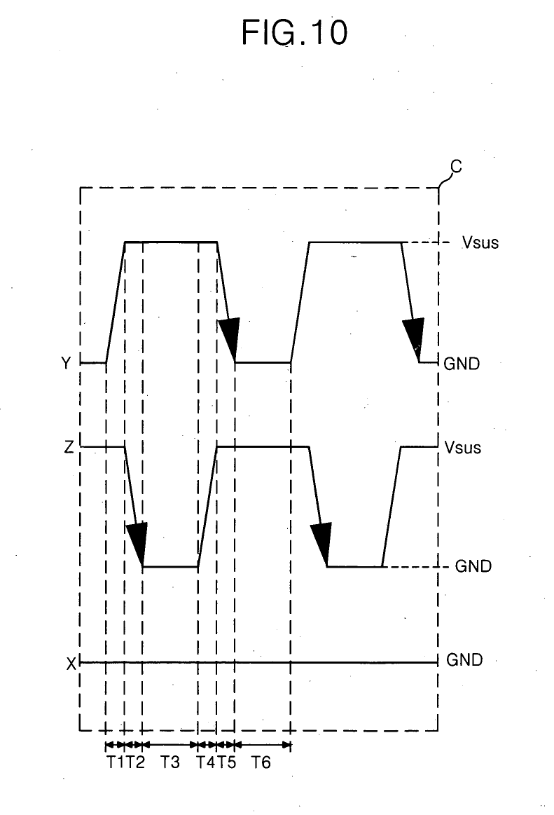

FIG. 9 is a diagram of a waveform illustrating a driving method of a PDP according to a third embodiment of the present invention. FIG. 10 is a diagram of a waveform illustrating an enlarged portion ‘C’ of the sustain period SPD shown in FIG. 9.

Referring to FIGS. 9 and 10, the driving waveform for the PDP according to the third embodiment of the present invention is divided into: a reset period RPD to apply a reset pulse RP to a scan electrode Y for each sub-field of one frame so as to generate a reset discharge, to thereby initialize a discharge cell, in order to display a designated image; an address period APD to supply a data pulse to an address electrode X and, at the same time, to apply a scanning pulse SP to the scan electrode Y so as to generate an address discharge, to thereby select the discharge cell; and a sustain period SPD to partially overlap a second sustain pulse SUSPZ applied to the sustain electrode Z with a first sustain pulse SUSPY applied to the scan electrode Y so as to generate a sustain discharge during every falling interval T2 of the second sustain pulse SUSPZ and every falling interval T5 of the first sustain pulse SUSPY, to thereby maintain the discharge of the selected cell that was selected during the address period APD.

The driving method of a PDP according to the third embodiment of the present invention is the same as the first embodiment of the present invention, except for the sustain period SPD. Accordingly, descriptions of the reset period RPD and the address period APD will be omitted. However the description of the sustain period SPD for the third embodiment is set forth herein below.

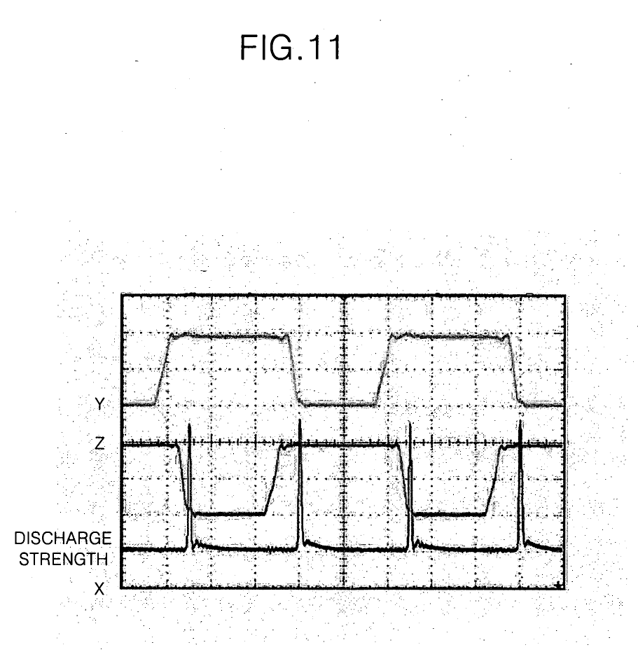

In the sustain period SPD of the driving method of a PDP according to the third embodiment of the present invention, second sustain pulses SUSPZ and first sustain pulses SUSPY having a sustain voltage Vsus are alternatively applied to the sustain electrode Z and the scan electrode Y, respectively. In other words, in the driving method of the PDP according to the third embodiment of the present invention, the first sustain pulse SUSPY, having the sustain voltage Vsus, is applied to the scan electrode Y such that it partially overlaps with a second sustain pulse SUSPZ after the second sustain pulse SUSPZ, having the sustain voltage Vsus, is applied to the sustain electrode Z. Accordingly, during the sustain period SPD, the sustain voltage Vsus is added to the wall voltage within a cell selected during the address period APD, to thereby generate a sustain discharge, that is, a display discharge, every falling intervals T2 and T5, where the voltage level of the second pulse SUSPZ and the first sustain pulse SUSPY, applied to the sustain electrode Z and the scan electrode Y falls, as shown in FIG. 11. More specifically, the second sustain pulse SUSPZ falls from the sustain voltage Vsus to the ground voltage GND in the second interval T2 of a high potential clamping interval, at which time, the first sustain pulse SUSPY maintains the sustain voltage Vsus. The second sustain pulse SUSPZ then maintains the ground voltage GND in the third interval T3 and, thereafter, rises from the ground voltage GND to the sustain voltage Vsus in the fourth interval T4. The voltage level of the first sustain pulse SUSPY then falls from the sustain voltage Vsus to the ground voltage GND in the fifth. interval T5 of the high potential clamping interval, at which time, the second sustain pulse SUSPZ maintains the sustain voltage Vsus. The first sustain pulse then maintains the ground voltage GND in the sixth interval T6 and, thereafter, rises from the ground voltage GND to the sustain voltage Vsus in the first interval T1. It is noted that the high potential clamping interval, where the first and the second sustain pulses SUSPY and SUSPZ maintain the sustain voltage Vsus, is longer than the low potential clamping interval, where the first and the second sustain pulses SUSPY and SUSPZ maintain the ground voltage GND.

More particularly, a strong surface discharge is generated between the sustain electrode Z and the scan electrode Y as a result of the falling voltage level of the second sustain pulse SUSPZ and, at the same time, an opposition discharge is generated between the sustain electrode Z and the address electrode X in the T2 interval, where the voltage of the second sustain pulse SUSPZ applied to the sustain electrode Z falls from the sustain voltage Vsus to the ground voltage GND, while at the same time the sustain voltage Vsus is applied to the scan electrode Y and the ground voltage GND is applied to the address electrode X.

Subsequently, a surface discharge is generated between the scan electrode Y and the sustain electrode Z as a result of the falling voltage level of the first sustain pulse SUSPY, and at the same time an opposition discharge is generated between the scan electrode Y and the address electrode X in the T5 interval, where the voltage level of the first sustain pulse SUSPY applied to the scan electrode Y falls from the sustain voltage Vsus to the ground voltage GND, while at the same time the sustain voltage Vsus is applied to the sustain electrode Z and the ground voltage GND is applied to the address electrode X.

On the other hand, a sustain discharge does not occur in non-selected cells, that is, cells not selected in the address period APD because the sum of the wall voltage within the non-selected cells and an external voltage is lower than the firing voltage during the sustain period SPD.

After the completion of the sustain discharge, an erasing signal (not shown) for erasing the wall charge remaining within the cells is applied to the scan electrode Y or the sustain electrode Z.

As mentioned above, the driving method of a PDP according to the third embodiment of the present invention generates a sustain discharge during the falling intervals T2 and T6, to thereby minimize discharge delay of the sustain discharge. Thus, it is possible to minimize image sticking caused when a specific picture (e.g., a still image) is displayed over a given time period. Further, the driving method of a PDP according to the third embodiment of the present invention involves the partial overlap of the first sustain pulse SUSPY with the second sustain pulse SUSPZ to simultaneously generate a surface discharge and an opposition discharge in the sustain discharge, to thereby improve discharge efficiency and brightness, and to decrease the sustain period SPD, thereby reducing a power consumption.

The structural components associated with a driving apparatus for a PDP according to the present invention are substantially the same as existing driving circuits for scan and sustain electrodes. It is the control of the operation timing of switch devices that is markedly different from existing devices as the operation timing generates a phase difference between a partial interval of a potential clamping interval of both the first sustain pulse SUSPY and the second sustain pulse SUSPZ and a voltage variation interval, as shown in FIGS. 3 to 11.

As described above, the driving method of a PDP according to the exemplary embodiments of the present invention result in a partial overlap of the sustain pulses applied to the scan electrode and the sustain electrode in the sustain period SPD to generate a sustain discharge every rising interval and falling interval of the sustain pulse applied to the scan electrode, to generate the sustain discharge every rising interval and falling interval of the sustain pulse applied to the sustain electrode, or to generate the sustain discharge every falling interval of the sustain pulse applied to the scan electrode and falling interval of the sustain pulse applied to the sustain electrode. In doing so, the present invention minimizes discharge delay of the sustain discharge, to thereby minimize image sticking caused when a specific picture (e.g., a still image) is displayed during a given time period. Further, the present invention partially overlaps the sustain pulse applied to the scan electrode and the sustain pulse applied to the sustain electrode to simultaneously generate a surface discharge and an opposition discharge in the sustain discharge, to thereby improve discharge efficiency and brightness, and to decrease the sustain period SPD, to thereby reduce power consumption.

Although the present invention has been explained by the embodiments shown in the drawings described above, it should be understood to the ordinary skilled person in the art that the invention is not limited to the embodiments, but rather that various changes or modifications thereof are possible without departing from the spirit of the invention. Accordingly, 'the scope of the invention shall be determined only by the appended claims and their equivalents.

What is claimed is :

1. A plasma display device comprising:
a first driver configured for applying a first sustain pulse to a first electrode, the first sustain pulse having a high voltage level and a low voltage level;
a second driver configured for applying a second sustain pulse to a second electrode, the second sustain pulse having a high voltage level and a low voltage level; and
a controller configured for changing the voltage level of the first sustain pulse while the voltage level of the second sustain pulse is maintained at the high voltage level.

2. The plasma display device according to claim 1,
wherein the first driver is further configured such that the first sustain pulse includes a rising voltage interval, at which time the voltage level of the first sustain pulse rises from the low voltage level to the high voltage level, a high voltage potential clamping interval, at which time the voltage level of the first sustain pulse is maintained at the high voltage level, a falling voltage interval, at which time the voltage level of the first sustain pulse falls from the high voltage level to the low voltage level, and a low voltage potential clamping interval, at which time the voltage level of the first sustain pulse is maintained at the low voltage level; and
wherein the second driver is further configured such that the second sustain pulse is maintained at the low voltage level during the rising voltage interval and during the high voltage potential clamping interval, the second sustain pulse then rises from the low voltage level to the high voltage level during the high voltage potential clamping interval, the second sustain pulse is then maintained at the high voltage level during the falling voltage interval and during the low voltage clamping interval, and the second sustain pulse then falls from the high voltage level to the low voltage level during the low voltage clamping interval.

3. The plasma display device according to claim 2, wherein the first electrode is a scan electrode.

4. The plasma display device according to claim 2, wherein the first electrode is a sustain electrode.

5. The plasma display device according to claim 1,
wherein the first driver is further configured such that the first sustain pulse includes a rising voltage interval, at which time the voltage level of the first sustain pulse rises from the low voltage level to the high voltage level, a high voltage potential clamping interval, at which time the voltage level of the first sustain pulse is maintained at the high voltage level, a falling voltage interval, at which time the voltage level of the first sustain pulse falls from the high voltage level to the low voltage level, and a low voltage potential clamping interval, at which time the voltage level of the first sustain pulse is maintained at the low voltage level; and
wherein the second driver is further configured such that the second sustain pulse is maintained at the high voltage level during the rising voltage interval, the second sustain pulse then falls from the high voltage level to the low voltage level, is maintained at the low voltage level and then rises from the low voltage level to the high voltage level all during the high voltage potential clamping interval, and the second sustain pulse is maintained at the high voltage level during the falling voltage interval.

6. The plasma display device according to claim 5, wherein the time duration associated with the high voltage potential clamping interval is greater than the time duration during which the second sustain pulse is maintained at the low voltage level.

7. The plasma display device according to claim 5, wherein the first electrode is a scan electrode.

8. The plasma display device according to claim 5, wherein the first electrode is a sustain electrode.

9. A method of driving a plasma display device comprising:
applying a first sustain pulse to a first electrode, the first sustain pulse having a high voltage level and a low voltage level;
applying a second sustain pulse to a second electrode, the second sustain pulse having a high voltage level and a low voltage level; and
changing the voltage level of the first sustain pulse while maintaining the voltage level of the second sustain pulse at the high voltage level.

10. The method according to claim 9,
wherein the first sustain pulse includes a rising voltage interval, at which time the voltage level of the first sustain pulse rises from the low voltage level to the high voltage level, a high voltage potential clamping interval, at which time the voltage level of the first sustain pulse is maintained at the high voltage level, a falling voltage interval, at which time the voltage level of the first sustain pulse falls from the high voltage level to the low voltage level, and a low voltage potential clamping interval, at which time the voltage level of the first sustain pulse is maintained at the low voltage level; and
wherein the second sustain pulse is maintained at the low voltage level during the rising voltage interval and during the high voltage potential clamping interval, the second sustain pulse then rises from the low voltage level to the high voltage level during the high voltage potential clamping interval, the second sustain pulse is then maintained at the high voltage level during the falling voltage interval and during the low voltage clamping interval, and the second sustain pulse then falls from the high voltage level to the low voltage level during the low voltage clamping interval.

11. The method according to claim 10, wherein the first electrode is a scan electrode.

12. The method according to claim 10, wherein the first electrode is a sustain electrode.

13. The method according to claim 9,
wherein the first sustain pulse includes a rising voltage interval, at which time the voltage level of the first sustain pulse rises from the low voltage level to the high voltage level, a high voltage potential clamping interval, at which time the voltage level of the first sustain pulse is maintained at the high voltage level, a falling voltage interval, at which time the voltage level of the first sustain pulse falls from the high voltage level to the low voltage level, and a low voltage potential clamping interval, at which time the voltage level of the first sustain pulse is maintained at the low voltage level; and
wherein the second sustain pulse is maintained at the high voltage level during the rising voltage interval, the second sustain pulse falls from the high voltage level to the low voltage level, is then maintained at the low voltage level and then rises from the low voltage level to the high voltage level during the high voltage potential clamping interval, and the second sustain pulse is maintained at the high voltage level during the falling voltage interval.

14. The method according to claim 13, wherein the time duration associated with the high voltage potential clamping interval is greater than the time duration during which the second sustain pulse is maintained at the low voltage level.

15. The method according to claim 13, wherein the first electrode is a scan electrode.

16. The method according to claim 13, wherein the first electrode is a sustain electrode.

17. A method of driving a plasma display device comprising:
applying a first sustain pulse to a first electrode, wherein the first sustain pulse has a high voltage level and a low voltage level;
applying a second sustain pulse to a second electrode, wherein the second sustain pulse has a high voltage level and a low voltage level;
changing the voltage level of the first sustain pulse while maintaining the voltage of the second sustain pulse at the high voltage level; and
changing the voltage level of the second sustain pulse while maintaining the voltage of the first sustain pulse at the high voltage level.

18. The method according to claim 17,
wherein the first sustain pulse includes a rising voltage interval, at which time the voltage level of the first sustain pulse rises from the low voltage level to the high voltage level, a high voltage potential clamping interval, at which time the voltage level of the first sustain pulse is maintained at the high voltage level, a falling voltage interval, at which time the voltage level of the first sustain pulse falls from the high voltage level to the low voltage level, and a low voltage potential clamping interval, at which time the voltage level of the first sustain pulse is maintained at the low voltage level; and
wherein the second sustain pulse is maintained at the high voltage level during the rising voltage interval, the second sustain pulse then falls from the high voltage level to the low voltage level, is maintained at the low voltage level and then rises from the low voltage level to the high voltage level all during the high voltage potential clamping interval, and the second sustain pulse is maintained at the high voltage level during the falling voltage interval.

19. The method according to claim 18, wherein the time duration associated with the high voltage potential clamping interval is greater than the time duration during which the second sustain pulse is maintained at the low voltage level.
